(19) United States
(12) Patent Application Publication
(10) Pub. No.: US 2015/0338569 A1
(43) Pub. Date: Nov. 26, 2015

(54) ILLUMINATED PANELS AND METHOD OF USE

(71) Applicant: Jechiel HAIBY, Atlit (IL)

(72) Inventor: Jechiel HAIBY, Atlit (IL)

(21) Appl. No.: 14/718,130

(22) Filed: May 21, 2015

Related U.S. Application Data
(60) Provisional application No. 62/001,654, filed on May 22, 2014.

(51) Int. Cl. F21V 8/00

(52) U.S. Cl. CPC G02B 6/0076; G02B 6/0055; G02B 6/0088

(57) ABSTRACT

An illuminate panel is disclosed. The illuminated panel includes two flat transparent plates disposed parallel and close to each other and plurality of spacers disposed between the flat panels. The spacers are at least partially transparent and disposed comprised in planes that are parallel to each other. The illuminated panel also includes a plurality of illumination units disposed along a line at one end of the illuminated panel and parallel to the planes of the spacers. The illumination units are disposed so that their illumination is directed towards the space between the flat panels.

### CROSS REFERENCE TO RELATED APPLICATIONS

This Application claims the benefit of U.S. Provisional Application Ser. No. 62/001,654, filed May 22, 2014, which is hereby incorporated by reference in its entirety.

### SUMMARY OF THE INVENTION

An illuminated panel is disclosed comprising at least two flat plates disposed parallel to each other and spaced from each other, wherein the at least two plates are transparent, and the plates are disposed in parallel planes defined by a first and a second Cartesian axes. A plurality of spacers formed by flat transparent material are disposed between each two adjacent plates of the at least two flat plates, with each spacer being disposed along a line that is parallel to the first Cartesian axis and a third Cartesian axis, wherein the meeting of each of the spacers with each of the plates forms a first type junction line, and the crossing of each spacer with another spacer forms a second type junction line. A plurality of illumination units disposed along a line located adjacent and parallel to one edge of said plates is aligned with said first Cartesian axis, and at least part of the illumination of said illumination units is directed in a plane substantially parallel to said plates and located between each adjacent pair of said plates.

According to some embodiments, the grade of transparency of the plates and the grade of transparency of the spacers is between 10% and 90%.

According to some embodiments, the spacers are formed as straight flat material disposed parallel to each other and perpendicular to said plates.

According to further embodiments, the spacers are evenly spaced.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1AA present a transparent illuminated panel from a side view and from a front view, respectively, according to some embodiments of the present invention;

FIGS. 1B and 1BA present a transparent illuminated panel from a side view and from a front view, respectively, according to some embodiments of the present invention;

FIGS. 2A and 2B which are a side view and a front view of an illuminated panel, respectively, according to some embodiments of the present invention;

FIGS. 2C and 2D which are partial side views of an illuminated panel, according to some embodiments of the present invention;

FIG. 2E schematically represents the perception of illuminated dots as experienced by a viewer, according to some embodiments of the present invention;

FIGS. 3A and 3B, which schematically present illuminated panel 3000 in side view and front view, respectively, according to some embodiments of the present invention;

FIG. 3D which schematically presents a graphic illustration of the way refracted illumination dots of an illuminated panel are perceived by a viewer, according to some embodiments of the present invention;

FIG. 3C which is a close-up partial side view of the geometry of spacing ribs, according to some embodiments of the present invention;

FIGS. 4A and 4B, which schematically present an illuminated panel in a side view and a front view, according to some embodiments of the present invention;

FIG. 4C schematically presents a graphic illustration of the way refracted illumination dots of an illuminated panel are perceived by a viewer according to some embodiments of the present invention;

FIG. 5 and FIG. 5A schematically present a structure element with an illuminated panel in an isometric view and in a side view, respectively, according to some embodiments of the present invention;

FIG. 6 is an isometric schematic illustration of a structure comprising an illuminated structure element, according to some embodiments of the present invention; and

FIG. 7 is a schematic illustration of a control system configured to power illumination sources of an illuminated panel, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

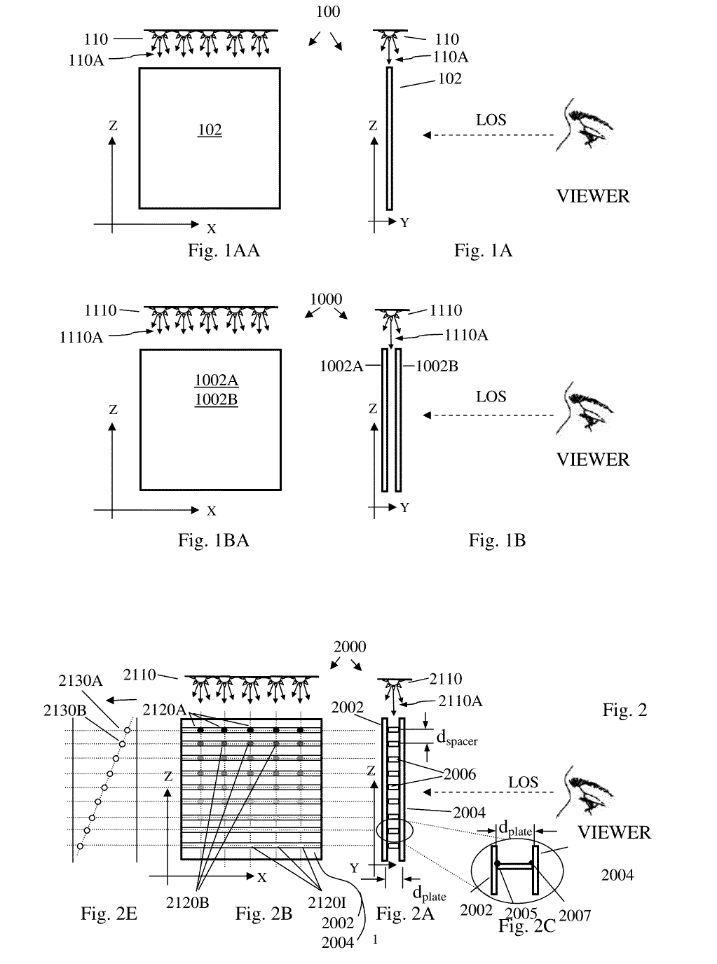

Reference is made to FIGS. 1A and 1AA, presenting transparent illuminated panel 100 from a side view and from a front view, respectively. Panel 100 comprise transparent plate 102 and plurality of light sources 110 disposed substantially along line parallel to the end of plate 102 aligned with Cartesian axis X. Plate 102 is disposed in the X-Z plane of a Cartesian reference system. The line of light sources 110 is disposed coplanar with plate 102 and parallel to the edge of plate 102 close to it and aligned with the X axis. At least portion 110A of the illumination of light sources 110 is directed towards plate 102 and in the plane of plate 102. The effect of the illumination of light sources 110 as viewed by a person in the LOS direction is minimal The LOS is directed substantially perpendicular to plate 102, parallel to axis Y of the Cartesian system. Transparent plate 102 may seem a bit brighter, and the brightness may very gradually decline at areas of plate 102 that are further from the edge of plate 102 that is adjacent to the line of light sources 110.

Reference is made now to FIGS. 1B and 1BA, presenting transparent illuminated panel 1000 from a side view and a front view, respectively. Panel 1000 comprises back transparent plate 1002A and front transparent plate 1002B disposed between plate 1002A and a viewer, and plurality of light sources 1110 disposed substantially along line parallel to the end of plates 1002A, 1002B, disposed substantially between them adjacent to one edge of plates 1002A, 1002B and aligned with Cartesian axis X.

At least portion 1110A of the illumination of light sources 1110 is directed towards plates 1002A, 1002B and into the plane between the plates. The effect of the illumination of light sources 1110 as viewed by a person in the LOS direction is minimal The LOS is directed substantially perpendicular to plate 1002A, 1002B, parallel to axis Y of the Cartesian system. Transparent plates 1002A, 1002B may seem a bit brighter, and the brightness may very gradually decline at areas of plates 1002A, 1002B that are further from the edges of the plates that are adjacent to the line of light sources 1110. However, most of the illumination portion 1110A of illumination source 1110 hits the internal faces of plates 1002A and 1002B at an angle smaller than the critical reflective angle and, therefore, is reflected back and does not penetrate through the plates to the outside of illuminated panel 1000.

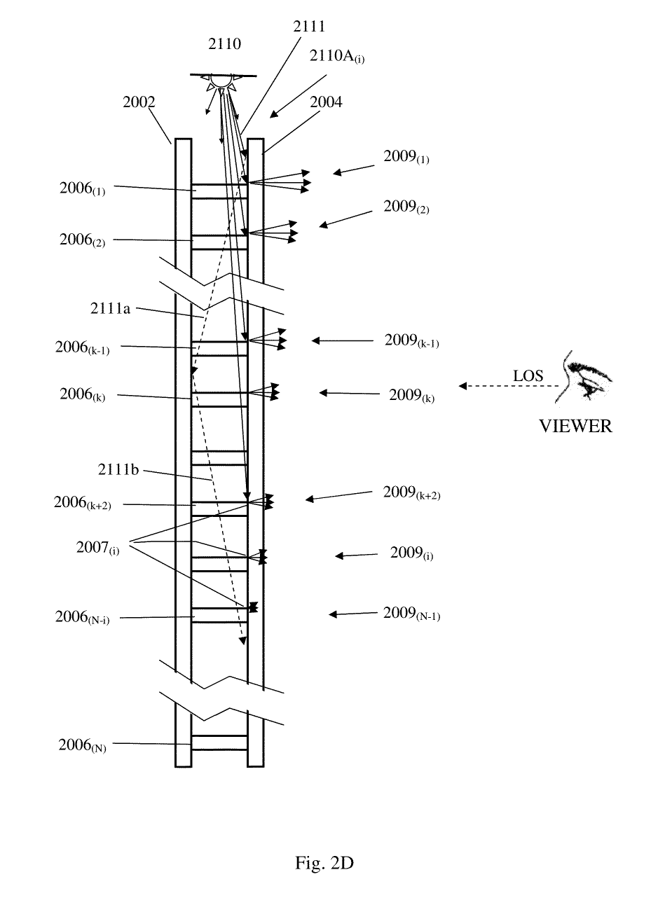

Reference is made now to FIGS. 2A and 2B, which are a side view and a front view, respectively, of illuminated panel 2000, according to some embodiments of the present invention. As is used here, front view is the view seen by the viewer, and side view is perpendicular to the front view. Illuminated panel 2000 comprise dual layer panel 2001 and plurality of light sources 2110 arranged along line that is coplanar with the gap between the plates 2002 and 2004 that are part of illuminated panel 2000. Plates 2002 and 2004 are disposed parallel to each other and spaced apart by gap dₚₗₐₜₑ. Dual layer panel 2001 further comprises plurality of spacing ribs 2006 disposed between plates 2002 and 2004. Ribs 2006 may be disposed perpendicular to the inner faces of plates 2002 and 2004 and parallel to each other spaced apart from each other by d_{space} and disposed parallel to the imaginary line of illumination sources 2110. Plates 2002 and 2004 and spacing ribs 2006 may be made of thin flat material having at least partial transparency, for example, thin plates of Polycarbonate (PC). The faces of plates 2002 and 2004 and ribs 2006 may be polished and glossy or matte, where the specific selection of the type of finishing of each of the elements may influence the appearance of the illuminated panel, as is described below. It will be noticed, however, that other configuration of ribs may be disposed between parallel plates 2002 and 2004, for example so that the ribs are parallel to line of illumination sources 2110 but inclined with respect to the inner faces of plates 2002 and 2004, whether parallel to each other or not, whether crossing each other or not. Spacing ribs may also be disposed not parallel to line of illumination lights 2110. These diverted configurations may have also influence of the appearance of illuminated panel, as is explained below.

Reference is made now also to FIGS. 2C and 2D which are partial side views of illuminated panel 2000. The contact points (as seen in side view) or the contact lines (as in 3D world) of rib 2006 with inner face of plate 2002 and 2004 are indicated in FIG. 2C by 2005 and 2007, respectively. Illumination portion 2110A of illumination source 2110 illuminates the inner gap between plates 2002 and 2004 by a plurality of illumination rays that flow from illumination sources 2110 in a range of angles in between the plates. Due to the position of illumination sources 2110, somewhat remote from the adjacent edges of plates 2002 and 2004, relative to the gap dₚₗₐₜₑ between the plates, most of the illumination rays of portion 2110A of illumination 2110 hit the inner faces of plates 2002 and 2004 at angles that are smaller than the total reflection (the critical) angle and, therefore, are reflected internally from inner face to inner face, as is presented by ray 2111 and its two consecutive inner reflections 2111a and 2111b. Indeed, the travel of reflected rays 2111 a and 2111b may cross through one or more spacing ribs 2006 and, therefore, may be slightly deviated from their path before the crossing and, in case ribs 2006 are not highly transparent, may gradually lose intensity, but it is not expected that ray such as ray 2111 that was internally reflected will travel through any of plates 2002 or 2004.

In order for the benefits and features of illuminated panel 2000 to be understood, the description herein below will focus on those illumination rays that hit the connection locations (points/lines) 2005, 2007 of spacing ribs 2006 with the internal faces of plates 2002 and 2004. Optically, these points/lines form optical irregularity where the angle that illumination ray 2110(i) meets inner face of plate 2002, 2004 or the face of rib 2006 facing illumination sources 2110 change abruptly. As a result, at least some of that rays are refracted in a wide illumination angle around connection location 2005, 2007 and at least some of the refracted illumination rays are directed towards the viewer, through plate 2004 in the example of FIG. 2D. Illuminated panel 2000 may comprise N spacing ribs 2006, where the spacing rib adjacent to illumination sources 2110 may be denoted 2006₍₁₎, the following spacing rib may be denoted 2006₍₂₎, etc. As seen in FIG. 2D, an illumination ray that hits the connection point of rib 2006(k) passes through k−1 spacing ribs. Depending on the grade of transparency of spacing ribs 2006, the decrease in the strength of the k-th ray is directly proportional to k−1 times the decrease of a single spacing rib 2006. Generally speaking, if the decrease in the illumination strength of an illumination ray when passing through one spacing rib is denoted m, and assuming that all spacing ribs have the same decreasing factor, the cumulative decrease in the illumination strength of an illumination ray hitting connection point 2005, 2007 of the k-th spacing rib will be m^{(k-1)}. Accordingly, for a dual plate panel having spacing ribs spaced apart evenly and having equal transparency, the illumination strength of refracted rays will decrease gradually and evenly as the refracting point is positioned farther from the location of illumination sources 2110.

As seen in FIG. 2B, the image of refraction points 2005 is seen by a viewer as dots 2120 aligned along lines corresponding to the connection lines of the respective spacing rib with plate 2004, where each dot 2120 in the image is the local image of one corresponding illumination source of the plurality illumination sources 2110. Accordingly, dots 2120A are aligned along a line positioned closest to illumination sources 2110, and dots 2120B are positioned spaced from dots 2120A and farther from illumination sources 2110. This pattern repeats for each of the spacing ribs where the illumination strength of the dots of certain line will seem less than the illumination strength of the corresponding to a spacing rib having lower index number, and it will seem stronger than the illumination source of the dots corresponding to a spacing rib having higher index number.

Reference is made now to FIG. 2E, which schematically represents the perception of the illuminated dots 2120 as experienced by the viewer. Due to the gradual decrease in the illumination strength of the refracted light as the index number of the corresponding spacing ribs gets higher, the viewer experiences the feeling that the distance of the lines of dots from him grows bigger as the strength of illumination decreases. Accordingly, the images 2130A of dots 2120A seem to the viewer to be the closest to the viewer (closest to the right of the page), and images 2130B of dots 2120B seem to the viewer to be farther from viewer more than images 2130A, etc.

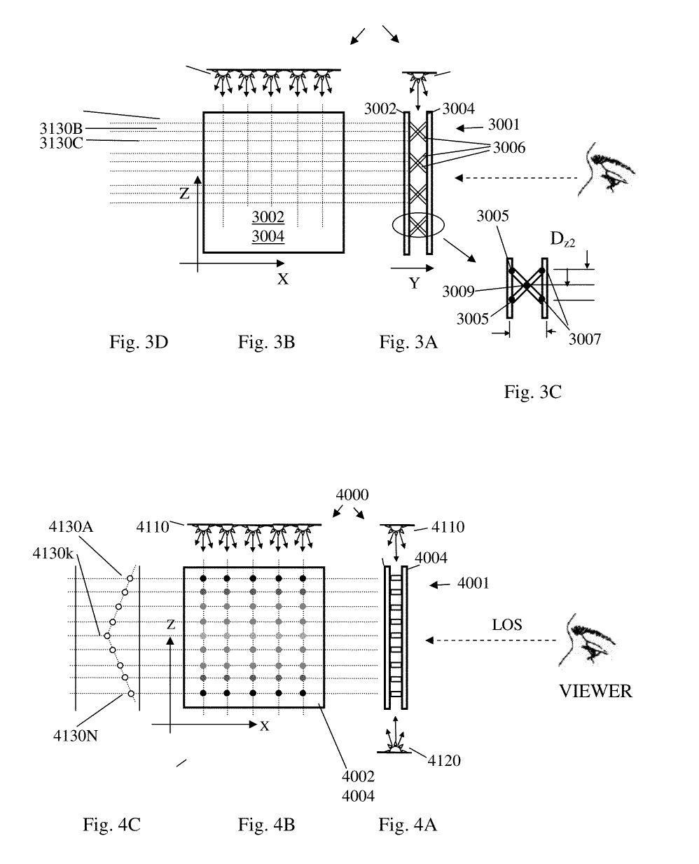

Reference is made to FIGS. 3A and 3B, which schematically present illuminated panel 3000 in side view and front view, respectively, to FIG. 3D which schematically presents graphic illustration of the way refracted illumination dots of illuminated panel 3000 are perceived by a viewer, and to FIG. 3C which is a close-up partial side view of the geometry of spacing ribs 3006, according to some embodiments of the present invention. Illuminated panel 3000 differs from illuminated panel 2000 mainly in the structure of the spacing ribs. Here, spacing ribs 3006 are not perpendicular to the faces of plates 3002, 3004, and two adjacent ribs are not parallel to each other. As seen in FIG. 3A, spacing ribs 3006 are disposed between the inner faces of plates 3002, 3004 inclined with respect to the faces of plates 3002, 3004 and substantially perpendicular to each other and cross each other, thereby forming series of X like structure of spacing ribs 3006. As a result, illumination rays that hit the connection points/lines 3005, 3007 and the cross points/lines 3009 pass through more ribs compared with the travel of rays of illuminated panel 2000, and the number of crossed ribs of certain X element is one for rays hitting upper point 2007 and point 2009 and two for rays hitting lower point 2007. Accordingly, the decrease in illumination strength is not linear as in illuminated plate 2000. As may be seen in FIG. 3D, the way a viewer perceives the images of the illuminated reflected points draws a picture in which the image of upper point 3007 and point 3009 seem to be located at similar distance from the viewer, while the image of lower point 3007 seems to the viewer at a longer distance from him, since its illumination strength is lower—as exemplified by points 3130A, 3130B and 3130C.

Reference is made now to FIGS. 4A and 4B, which schematically present illuminated panel 4000 in side view and front view, and to FIG. 4C which schematically presents graphic illustration of the way refracted illumination dots of illuminated panel 4000 are perceived by a viewer according to embodiments of the present invention. The main difference between illuminated panel 4000 and illuminated panel 2000 is that illuminated panel 4000 comprises two sets of illumination sources 4119 and 4120. The first is located adjacent to one edge of plates 4002, 4004, and the latter is located adjacent to the opposite edge of the plates, thus providing illumination from two opposite ends of the panel. Accordingly, spacing ribs that are close to either of illumination sources experience stronger illumination. As the rib is closer to the middle of plates 4002, 4004, the illumination strength decreases. According to the principles described at length with respect to FIGS. 2A-2D, the way the images of illuminated dots in illuminated panel 400 are perceived by the viewer is as if the central line of images of dots is farthest from the viewer and the lines of dots seem to be closer to the viewer as they are closer to the ends of the plates.

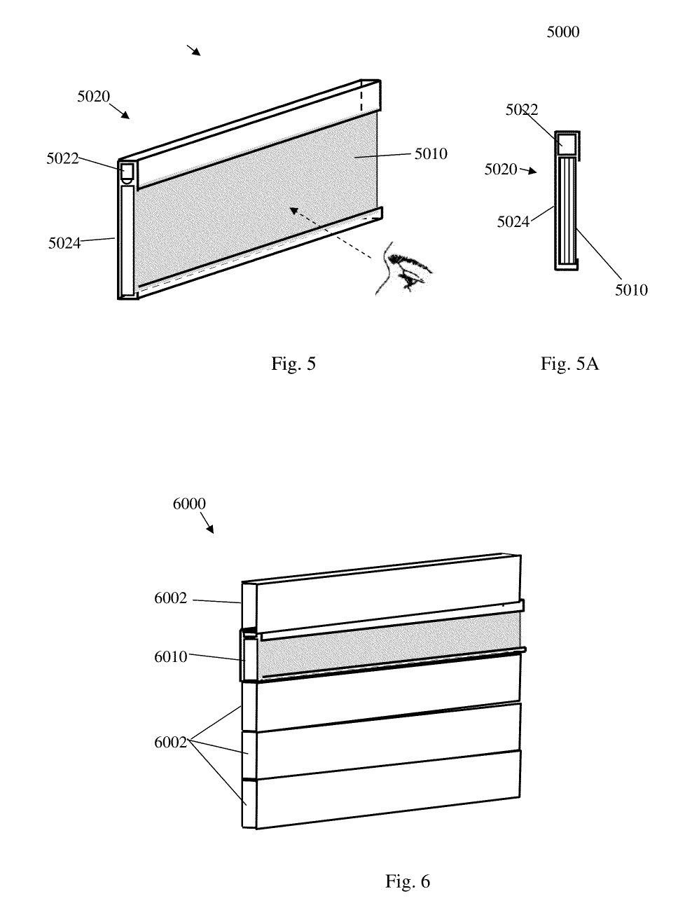

Reference is made now to FIG. 5 and FIG. 5A, which schematically present structure element 5000 with illuminated panel 5010 in isometric view and in side view, respectively, according to some embodiments of the present invention. Structure element 5000 may comprise support element 5020 that may be formed of a rigid thin material, such as steel or the like. Support element 5020 may be formed to provide lower and upper supporting edges designed to hold illuminated panel 5010 and provide housing to electronic unit 5022. Electronic unit 5022 may comprise power supply unit, control unit and illumination line, such as illumination line 2010. In this configuration, illuminated panel 5010 may be seen from one side only; however, it should be apparent that, with the required changes in the construction of support element 5024, both sides of illumination panel may be seen.

Reference is made to FIG. 6 which is an isometric schematic illustration of structure 6000 comprising illuminated structure element 6010, which may be similar or equal to illuminated structure element 5000. Structure element may be, for example, a fence unit comprising two or more fence elements 6002 and at least one illuminated structure element 6010. It would be apparent that other configurations of utilizing or embedding illuminated elements according to the present invention are possible within the scope of the present invention.

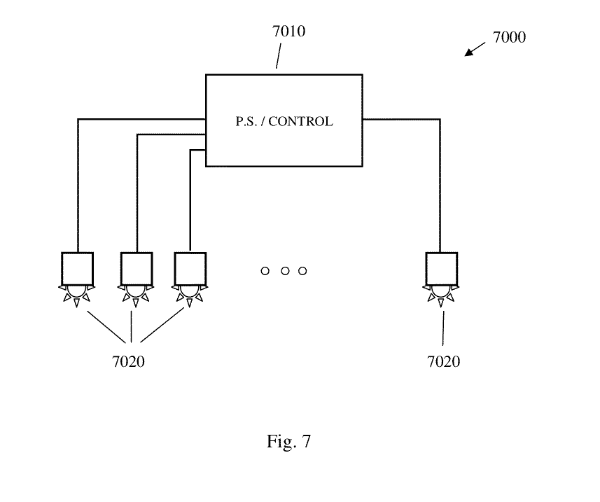

Reference is made now to FIG. 7 which is a schematic illustration of control system 7000 configured to power illumination sources of an illuminated panel, such as panel 2000 and panel 4000, according to some embodiments of the present invention. Control system 7000 may comprise central unit 7010 which may comprise power supply unit and control unit. The power supply unit may be any power supply known in the art that is adapted to provide the required power in the required voltage to illumination units 7020. The control unit may be or may comprise any controller, central processing unit (CPU) or programmable logic controller (PLC) or the like. The controller may comprise non transitory storage unit adapted to store programs and data which, when executed, perform the steps of operation of the illuminated unit according to some embodiments of the present invention. Power supply and control unit 7010 may be adapted to be programmed or tuned, for example, by a user to select or define his own or pre-programmed scheme of illumination. For example, the illumination scheme may comprise change of the intensity of illumination in time, blinking in various blinking schemes, change of the color of illumination if the illumination sources are adapted to provide multi-color illumination, and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An illuminated panel comprising:
at least two flat plates disposed parallel to each other and spaced from each other, the at least two plates are transparent, said plates are disposed in parallel planes defined by a first and a second Cartesian axes;
a plurality of spacers formed by flat transparent material disposed between each two adjacent plates of the at least two flat plates, each spacer is disposed along line that is parallel to said first Cartesian axis and a third Cartesian axis, the meeting of each of said spacers with each of said plates forms a first type junction line and the crossing of each spacer with another spacer forms a second type junction line; and
a plurality of illumination units disposed along a line located adjacent and parallel to one edge of said plates aligned with said first Cartesian axis, at least part of the illumination of said illumination units is directed in a plane substantially parallel to said plates and located between each adjacent pair of said plates.

2. The illuminated panel of claim 1, wherein the grade of transparency of said plates and the grade of transparency of said spacers is between 10% and 90%.

3. The illuminated panel of claim 1 wherein said spacers are formed as straight flat material disposed parallel to each other and perpendicular to said plates.

4. The illuminated panel of claim 2 wherein said spacers are evenly spaced.
